(19) United States
(12) Patent Application Publication
(10) Pub. No.: US 2026/0326362 A1
(43) Pub. Date: Oct. 22, 2026

(54) BIAXIALLY ORIENTED PET FILM AND MANUFACTURING METHOD THEREOF

(71) Applicant: NAN YA PLASTICS CORPORATION, Taipei City (TW)

(72) Inventors: Wen-Cheng Yang, Taipei City (TW); Chen An Wu, Taipei City (TW); Chia-Yen Hsiao, Taipei City (TW); Fan-Jie Lin, Taipei City (TW)

(73) Assignee: NAN YA PLASTICS CORPORATION, Taipei City (TW)

(21) Appl. No.: 19/237,037

(22) Filed: Jun. 13, 2025

Related U.S. Application Data
(60) Provisional application No. 63/760,637, filed on Feb. 20, 2025.

(30) Foreign Application Priority Data
Apr. 22, 2025 (TW) 114115136

(51) Int. Cl. B29C 55/12; B29C 48/00; B29C 48/08; B29K 67/00; B29K 105/26

(52) U.S. Cl. CPC B29C 55/12; B29C 48/0018; B29C 48/08; B29K 2067/003; B29K 2105/26

(57) ABSTRACT

A biaxially oriented PET film made of a PET resin mixture is provided, wherein the PET resin mixture includes a PET material and a crystallization inhibiting material, such that when the biaxially oriented PET film is analyzed by differential scanning calorimetry, when the biaxially oriented PET film is cooled from a molten state at cooling rates of 20° C./min and 40° C./min respectively, a difference between a first recrystallization temperature and a second recrystallization temperature observed is greater than 15° C. and less than or equal to 23° C. A manufacturing method of a biaxially oriented PET film is also provided.

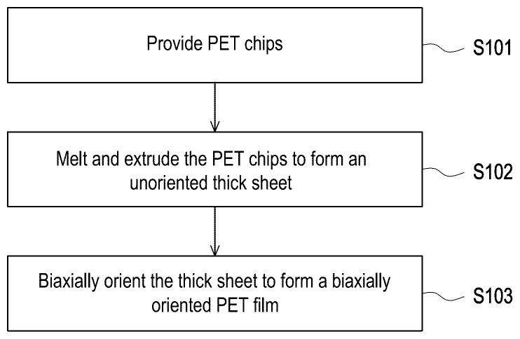

### CROSS-REFERENCE TO RELATED APPLICATION

This application claims the priority benefit of U.S. Provisional Application No. 63/760,637, filed on Feb. 20, 2025 and Taiwan Application No. 114115136, filed on Apr. 22, 2025. The entirety of each of the above-mentioned patent applications is hereby incorporated by reference herein and made a part of this specification.

### BACKGROUND OF THE INVENTION

### Field of the Invention

The invention relates to a biaxially oriented PET film and a manufacturing method thereof.

### Description of Related Art

In the production of a biaxially oriented PET film, how to improve crystallinity is an important issue. For example, when the biaxially oriented PET film is cooled from a molten state at cooling rates of 20° C./min and 40° C./min, respectively, if the difference between the two recrystallization temperatures observed is less than 15° C., the film may break readily during the production process due to excessive crystallinity. In addition, environmental issues are gradually gaining attention, and therefore how to design a biaxially oriented PET film having product competitiveness is a genuine challenge.

### SUMMARY OF THE INVENTION

The invention provides a biaxially oriented PET film and a manufacturing method thereof that may produce better productivity evaluation and thus achieve good product competitiveness.

The invention provides a biaxially oriented PET film made of a PET resin mixture, wherein the PET resin mixture includes a PET material and a crystallization inhibiting material, such that when the biaxially oriented PET film is analyzed by differential scanning calorimetry, when the biaxially oriented PET film is cooled from the molten state at cooling rates of 20° C./min and 40° C./min respectively, a difference between a first recrystallization temperature and a second recrystallization temperature observed is greater than 15° C. and less than or equal to 23° C.

In an embodiment of the invention, a molar percentage concentration of the crystallization inhibiting material in the PET resin mixture is between 2 mol % and 8 mol %.

In an embodiment of the invention, the crystallization inhibiting material includes isophthalic acid, neopentyl glycol, diethylene glycol, 1,4-cyclohexanedimethanol, or a combination thereof.

In an embodiment of the invention, the crystallization inhibiting material is a combination of isophthalic acid and diethylene glycol.

In an embodiment of the invention, the PET material includes a recycled PET material, a virgin PET material, or a combination thereof.

In an embodiment of the invention, the first recrystallization temperature is greater than 170° C.

In an embodiment of the invention, the second recrystallization temperature is between 150° C. and 175° C.

In an embodiment of the invention, a thickness of the biaxially oriented PET film is greater than 10 micrometers.

A manufacturing method of a biaxially oriented PET film of the invention includes the following steps: melting and extruding one or more PET chips to form an unoriented thick sheet, wherein the PET chips at least include chemically recycled PET chips, and the chemically recycled PET chips have a higher content of a crystallization inhibiting material than physically recycled PET chips, wherein the molten PET chips are a PET resin mixture; and biaxially orienting the thick sheet to form the biaxially oriented PET film, wherein the biaxially oriented PET film is analyzed by differential scanning calorimetry, and when the biaxially oriented PET film is cooled from a molten state at cooling rates of 20° C./min and 40° C./min, respectively, a difference between a first recrystallization temperature and a second recrystallization temperature observed is greater than 15° C. and less than or equal to 23° C.

In an embodiment of the invention, the PET chips further include one or two of virgin PET chips and physically recycled PET chips.

Based on the above, the invention introduces the crystallization inhibiting material into the PET resin mixture, and improves the crystallinity of the biaxially oriented PET film via the crystallization inhibiting effect thereof, so as to produce better productivity evaluation, thereby achieving good product competitiveness. For example, since recycled materials contain many unavoidable impurities (such as non-PET plastics caused by inaccurate classification, inorganic or organic impurities caused by inaccurate cleaning, and colorants or dye impurities of recycled materials themselves having colors due to original product requirements thereof), when the recycled materials are directly used to prepare a PET film, the crystallinity of the PET resin mixture is significantly increased due to their own impurities, resulting in significant film breakage during orientation. Moreover, in some cases, even if the recycled materials themselves may contain a small amount of crystallization inhibiting materials, the content thereof is so small that the issue may still not be overcome. Therefore, the invention additionally introduces the crystallization inhibiting material when preparing chemical environmentally friendly chips to maintain a balance between productivity and/or mechanical strength.

### BRIEF DESCRIPTION OF THE DRAWINGS

FIGURE is a schematic flow diagram of a manufacturing method of a biaxially oriented PET film according to an embodiment of the invention.

### DESCRIPTION OF THE EMBODIMENTS

In the following detailed description, for explanation and not limitation, exemplary embodiments disclosing specific details are set forth in order to provide a thorough understanding of the various principles of the invention. However, it will be apparent to one skilled in the art, having benefit of the disclosure, that the invention may be practiced in other embodiments departing from the specific details disclosed herein. Moreover, descriptions of well-known devices, methods, and materials may be omitted so as not to obscure the description of the various principles of the invention.

Ranges may be expressed herein as from “about” one particular value to “about” another particular value, which may also be expressed directly to one particular value and/or to another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, or independently of the other endpoint.

In this text, non-limiting terms (such as: may, can, for example, or other similar terms) mean non-compulsory or optional implementation, inclusion, addition, or existence.

Unless otherwise defined, all terms (including technical terms and scientific terms) used herein have the same meaning as commonly understood by those having ordinary skill in the art. It will also be understood that terms (such as those defined in commonly used dictionaries) should be interpreted as having a meaning consistent with the meaning thereof in the relevant technical context, and should not be interpreted in an idealized or overly formal sense, unless expressly so defined herein.

FIGURE is a schematic flow diagram of a manufacturing method of a biaxially oriented PET film according to an embodiment of the invention. Please refer to FIGURE. In step S101, PET chips are provided, wherein the PET chips may be at least formed by a recycled PET material, and may further include a virgin PET material. Further, the recycled PET material may include a crystallization inhibiting material. In step S102, the PET chips are melted (which may be referred to as a PET resin mixture) and extruded to form an unoriented thick sheet. In step S103, the thick sheet is biaxially oriented to form the biaxially oriented PET film, wherein the biaxially oriented PET film is analyzed by differential scanning calorimetry (DSC), and when the biaxially oriented PET film is cooled from a molten state at cooling rates of 20° C./min and 40° C./min, respectively, the difference between the two recrystallization temperatures observed is greater than 15° C. and less than or equal to 23° C. (for example, 16° C., 17° C., 18° C., 19° C., 20° C., 21° C., 22° C., 23° C., or any suitable value greater than 15° C. and less than or equal to 23° C.). Accordingly, the invention introduces a crystallization inhibiting material into the PET resin mixture, and improves the crystallinity of the biaxially oriented PET film via the crystallization inhibiting effect thereof, so as to produce better productivity evaluation, thereby achieving good product competitiveness. Here, when cooling from a molten state at cooling rates of 20° C./min and 40° C./min, the recrystallization temperatures observed are the first recrystallization temperature and the second recrystallization temperature, respectively.

In some embodiments, the weight ratio of the virgin PET material to the PET resin mixture is between 0 wt % and 50 wt % (for example, 0 wt %, 5 wt %, 10 wt %, 20 wt %, 45 wt %, 50 wt %, or any suitable value between 0 wt % and 50 wt %), and the weight ratio of the recycled PET material to the PET resin mixture is between 50 wt % and 100 wt % (for example, 55 wt %, 60 wt %, 70 wt %, 80 wt %, 95 wt %, 100 wt %, or any suitable value between 50 wt % and 100 wt %), so as to meet environmental protection requirements. Moreover, since the recycled PET material often has impurities that may serve as a crystal nucleating agent (especially when the chemically recycled PET chips are greater than 10 wt %), the use of the recycled PET material is more likely to result in a higher crystallinity of the thick sheet before orientation, resulting in film breakage phenomenon during the orientation process, which is a bottleneck that is difficult to overcome technically. However, in the invention, by introducing the crystallization inhibiting material, excellent productivity may be achieved while using a high content of the recycled PET material.

In some embodiments, the crystallization inhibiting material includes isophthalic acid (IPA, CAS No: 121-91-5), neopentyl glycol (NPG, CAS No: 126-30-7), diethylene glycol (DEG, CAS No: 111-46-6), 1,4-cyclohexanedimethanol (CHDM, CAS No: 105-08-8), or a combination thereof, and preferably the crystallization inhibiting material is a combination of isophthalic acid and diethylene glycol.

In some embodiments, the molar percentage concentration of the crystallization inhibiting material in the PET resin mixture is between 2 mol % and 8 mol % (for example, 2 mol %, 3 mol %, 4 mol %, 5 mol %, 6 mol %, 7 mol %, 8 mol %, or any suitable value between 2 mol % and 8 mol %). Too little crystallization inhibiting material also has an adverse effect on the subsequent process, such as being lower than the above lower limit readily causes the crystallinity to be too high, resulting in film breakage phenomenon during the orientation process, and being higher than the upper limit readily causes the crystallinity may be too low, thereby reducing physical properties. Therefore, within the above ratio range, the crystallinity may be more accurately controlled to further enhance product competitiveness.

In some embodiments, the PET resin mixture is formed by a PET material and a crystallization inhibiting material, that is, the total weight of the PET material and the crystallization inhibiting material is 100 wt % of the PET resin mixture, but the invention is not limited thereto. The PET resin mixture may also include other additives, such as a PET resin mixture for which the total weight of the PET material, the crystallization inhibiting material, and other additives (such as a slipping agent, etc.) is 100 wt %.

In some embodiments, the first recrystallization temperature is greater than 170° C., preferably between 170° C. and 190° C., and may be greater than 175° C., and the second recrystallization temperature is between 150° C. and 175° C., preferably between 155° C. and 175° C., and may also be between 165° C. and 175° C. In the invention, by introducing at least the crystallization inhibiting material, the recrystallization temperature may still achieve good orientation in the process even in the above higher temperature range.

In some embodiments, the melting point of the biaxially oriented PET film is between 243° C. and 253° C. (e.g., 243° C., 245° C., 247° C., 249° C., 251° C., 253° C., or any suitable value between 243° C. and 253° C.).

In some embodiments, the thickness of the biaxially oriented PET film is between 8 microns and 350 microns, and preferably the thickness of the biaxially oriented PET film is between 10 microns and 350 microns, and may also be between 50 microns and 350 microns to have better structural strength, but the invention is not limited thereto.

In some embodiments, the PET resin mixture further includes a slipping agent, wherein the weight ratio of the slipping agent to the PET resin mixture is between 0.05 wt % and 2 wt % (for example, 0.05 wt %, 1 wt %, 1.5 wt %, 2 wt %, or any suitable value between 0.05 wt % and 2 wt %), and the particle size is between 0.05 microns and 5 microns (for example, 0.05 microns, 0.1 microns, 0.3 microns, 0.35 microns, 0.4 microns, 0.5 microns, 5 microns, or any suitable value between 0.05 microns and 5 microns). The slipping agent may be in granular form. For example, the slipping agent may include silicon dioxide particles, calcium carbonate particles, barium sulfate particles, polystyrene particles, silica particles, acrylic particles, or a combination thereof.

In some embodiments, the biaxially oriented PET film may be a single-layer structure or a multi-layer structure of skin layer/base layer/skin layer, and both the base layer and the skin layer may be formed by the PET resin mixture, wherein in the multi-layer structure design, the thickness of the skin layer may account for 2% to 30% of the total thickness of the biaxially oriented PET film (for example, 2%, 3%, 4%, 10%, 15%, 20%, 30%, or any suitable value between 2% and 30%).

The specific details of each of the above steps are described in detail below, but these details are only used for clear exemplary description and are not used to limit the invention. Those having ordinary skill in the art may make appropriate adjustments and modifications according to these contents.

### [Recycled PET Material]

The recycling method of the PET material includes, for example: collecting various types of waste PET materials; classifying the waste PET materials according to types, colors, and/or previous uses thereof; then, compressing and packaging the classified waste PET materials; and then, transporting the packaged waste PET materials to a waste treatment plant. The waste PET materials may include, for example, recycled PET bottles, but the invention is not limited thereto.

The recycling method of the PET material may further include removing objects (such as bottle caps, labels, and/or adhesives) from the waste PET materials. Next, the above waste PET materials are physically and mechanically crushed; then, the crushed PET materials are separated using an appropriate method (such as flotation); thereafter, the crushed and separated waste PET materials are dried to obtain processed recycled PET materials.

In an embodiment, the recycled PET materials may be further recycled (e.g., recycling of the ear material after cutting) by forming a biaxially oriented PET film via the method described below.

It should be noted that the terms “PET”, “PET material”, and the like herein refer to any type of PET, in particular to aromatic PET, and in particular to PET (i.e., polyethylene terephthalate (PET)) derived from purified terephthalic acid (PTA) and ethylene glycol (EG).

In addition, the PET herein may also be, for example, poly(trimethylene terephthalate), poly(butylene terephthalate), polyethylene naphthalate, or a combination thereof. In the present embodiment, the PET is preferably polyethylene terephthalate, polytrimethylene terephthalate, or a combination thereof. Furthermore, a copolymer may also be used, and this refers to a copolymer obtainable by using two or more dicarboxylic acids and/or two or more diol components.

In some embodiments, the recycled PET materials (chemically recycled PET chips, physically recycled PET chips) obtained by the following methods may be further formed into recycled PET chips for a subsequent thin film manufacturing process.

### [Manufacturing Method of Chemically Recycled PET Chips] (May Contain Crystallization Inhibiting Material)

First, the recycled PET materials are chemically depolymerized. For example, the recycled PET materials and the depolymerisation liquid may be placed in a suitable depolymerisation tank for chemical depolymerisation, wherein the chemical depolymerisation liquid may substantially break the PET molecules in the recycled PET materials, thereby achieving depolymerisation effect. Furthermore, it is possible to obtain PET compositions with shorter molecular chains and/or ester monomers composed of a diacid unit and two diol units (e.g., bis(2-hydroxyethyl)terephthalate (BHET)). That is, the average molecular weight of the mixture after chemical depolymerization is substantially less than the average molecular weight of the recycled PET materials. In addition, the invention does not limit the type of the depolymerization liquid. For example, hydrolysis may be performed via water. For another example, alcoholysis may be performed via alcohol (such as methanol, ethanol, ethylene glycol, diethylene glycol, or a mixture thereof). In an embodiment, the depolymerization liquid is preferably alcohol. The more suitable alcoholysis liquid is ethylene glycol. One of the reasons may be that ethylene glycol may be a reactive monomer for producing virgin PET chips.

Next, the product after the above chemical depolymerization reaction is subjected to an esterification reaction. It should be noted that the invention is not limited to all PET materials being completely depolymerized. For example, the product after the chemical depolymerization reaction may be transferred to a suitable esterification tank for esterification reaction. In an embodiment, before the product after the chemical depolymerization reaction is moved into the esterification tank, filtering may be performed first via a filter screen to remove at least a portion of the impurities in the recovered PET material, thereby reducing the concentration of non-PET impurities. However, components with smaller particle sizes (such as metal impurities and the like) may still exist in trace amounts. In an embodiment, the pore size of the filter screen may be between 1 micron and 10 microns. In some embodiments, after the above esterification reaction is performed for a period of time, other additives, i.e., a component such as a crystallization inhibiting material, a slipping agent, a stabilizer, etc. may be further added to the esterification tank. In some embodiments, the chemical recovery method may also additionally add terephthalic acid or other crystallization inhibiting monomers, such as isophthalic acid, neopentyl glycol, diethylene glycol, 1,4-cyclohexanedimethanol, or a combination thereof, and the added amount thereof may be between 1 mol % and 20 mol % of the PET resin mixture to adjust the properties of the film, but the invention is not limited thereto.

Then, the product after the esterification reaction is subjected to polymerization reaction. For example, the product after the esterification reaction may be transferred to a suitable polymerization tank for polymerization reaction. Lastly, PET chips are formed. For example, the above polymerization reaction is performed until the material in the tank has a corresponding intrinsic viscosity (IV). Next, the material in the tank is extruded and/or pelletized via a common granulation method for general polymer chips to form PET chips. In the present embodiment, the intrinsic viscosity of the PET chips formed by the chemical reprocessing operation is generally between 0.5 dL/g and 0.8 dL/g; for example, between 0.6 dL/g and 0.78 dL/g.

In an embodiment, the PET chips formed by the chemical reprocessing operation may be referred to as chemically recycled PET chips having a high content of crystallization inhibiting material. Adding chemically recycled PET chips during film making may reduce the crystallinity of the PET mixture during film making and avoid film breakage during the production process. Therefore, the PET chips used to form the biaxially oriented PET film at least include chemically recycled PET chips.

### [Manufacturing Method of Physically Recycled PET Chips]

In the present embodiment, the recycled PET materials may be melted to be in a molten state. Then, the recycled PET materials in molten state may be filtered via a filter screen to remove solid impurities in the recycled PET materials. Next, the filtered recycled PET materials may be extruded and granulated via an extruder (such as a commercially available single-screw extruder (SSE), twin-screw extruder (TSE), or other similar screw extruders, but not limited to) to form physically recycled environmentally friendly PET chips. In an embodiment, before the recycled PET materials are melted, the recycled PET materials may be physically and mechanically crushed to reduce the time and/or energy consumption needed for melting the recycled PET materials. Moreover, the above method reshapes the recycled PET materials via the steps of cutting, melting, filtering, and extruding. In other words, physically recycled environmentally friendly PET chips basically do not go through the steps of depolymerization and then polymerization, and the process only involves melting, filtering, and granulation.

In the present embodiment, in the physical reprocessing process, the recycled PET materials only undergo the steps of melting, filtering, and granulating. Therefore, the components originally present in the recycled PET materials (for example, materials such as metal impurities) still exist in the physically recycled PET chips. That is, some properties of the physically recycled PET chips may be the same or similar to some properties of the originally used recycled PET materials. In an embodiment, the average molecular weight of the recycled PET materials during the physical reprocessing process substantially may not be changed much (compared to the chemically recycled PET chips). That is, the viscosity of the recycled PET materials in the molten state may be higher (i.e., lower fluidity). Therefore, if a filter screen with a pore size that is too small is used, the filtration efficiency may be reduced. In an embodiment, the mesh size of the sieve is preferably between 10 microns and 100 microns, but the invention is not limited thereto.

The physically recycled PET chips produced by the physical reprocessing operation generally have a higher intrinsic viscosity. In the present embodiment, the intrinsic viscosity of the physically recycled PET chips may be between 0.5 dL/g and 0.8 dL/g; for example, between 0.6 dL/g and 0.78 dL/g.

In an embodiment, the PET chips formed by the physical reprocessing operation may be referred to as physical recycled PET chips.

### [Manufacturing Method of Virgin PET Chips]

The manufacture may be performed in the same or similar manner as the above [Manufacturing method of chemically recycled PET chips], except that terephthalic acid and ethylene glycol may be directly added to the esterification tank for esterification reaction. In the present embodiment, the intrinsic viscosity of the PET chips formed by the above method may generally be between 0.5 dL/g and 0.8 dL/g; for example, between 0.6 dL/g and 0.78 dL/g.

In an embodiment, the PET chips formed by the above method may be referred to as virgin PET chips.

### [Manufacturing Method of Biaxially Oriented PET Film]

In the present embodiment, at least two of the above PET chips (such as one or both of the chemically recycled PET chips, the virgin PET chips, and the physically recycled PET chips) may be directly used or mixed in appropriate proportions according to design requirements.

In an embodiment, the PET chips may be dried via heating and/or placing under low pressure. For example, the PET chips may be vacuum dried under the condition of about 120° C. to 180° C. for about 3 hours to 8 hours.

Then, the PET chips (may be dried PET chips, but not limited to) are heated, melted, and extruded. For example, the PET chips may be melted under the condition of about 200° C. to 290° C. via an extruder (such as, but not limited to, a commercially available single-screw extruder) and the molten PET may be extruded to form an unoriented thick sheet.

Next, the thick sheet may be subjected to a corresponding biaxial orientation step in a common manner of a general biaxially oriented PET film. For example, an unoriented thick sheet may be first introduced into a longitudinal orientation machine to be longitudinally oriented to form a corresponding thin film (i.e., a thick sheet that is longitudinally oriented). Then, the thin film may be introduced into a horizontal orientation machine to be oriented horizontally to form a biaxially oriented PET film (i.e., a thin film that is oriented horizontally).

To give a detailed example, the thick sheet may be longitudinally oriented 2 to 6 times in the length direction parallel to the conveying direction thereof (can be referred to as: longitudinal direction; machine direction; MD) at about 70° C. to 145° C., and then the thick sheet may be longitudinally oriented 2 to 6 times in the width direction of the thin film (i.e., another direction perpendicular to the length direction, may be referred to as: horizontal direction; transverse direction; TD) at about 90° C. to 160° C., that is, the longitudinal orientation process and the horizontal orientation process are performed successively, but the invention is not limited thereto. In other embodiments, the longitudinal orientation process and the horizontal orientation process may be performed simultaneously at about 70° C. to 160° C. using an orientation ratio of 2 to 6 times. Furthermore, in some embodiments, the biaxially oriented PET film may be pre-shrunk in the horizontal direction and/or the longitudinal direction.

Via the above steps, the manufacture of the biaxially oriented PET film of the present embodiment is substantially completed. In an embodiment, according to design requirements, a portion of the film (e.g., the ear material) may be cut off after the horizontal orientation is performed. The biaxially oriented PET film may be stored in a roll-up form; or, further sold and/or used.

### EXAMPLES AND COMPARATIVE EXAMPLES

Although the invention is described in detail below with reference to Examples and Comparative examples, the invention is not limited to the following Examples at all.

Each of the Examples and Comparative examples may be a corresponding biaxially oriented PET film formed by the above method. The difference is: the usage ratio of the PET chips and the crystallization inhibiting material is adjusted, wherein the crystallization inhibiting material used is a combination of isophthalic acid and diethylene glycol.

The biaxially oriented PET films of [Example 1] to [Example 8] and [Comparative example 1] to [Comparative example 2] in [Table 1] were tested. The results show that if the orientation conditions were adjusted significantly, production control was difficult, thereby affecting production efficiency. The invention introduced a crystallization inhibitory material. Via the crystallization inhibitory effect thereof, the orientation conditions did not need to be adjusted, and the crystallinity of the biaxially oriented PET film may indeed be improved to produce better productivity evaluation, thereby achieving good product competitiveness. The test items included the film breakage rate of the biaxially oriented PET film (expressed as “Film breakage rate (occurrence/24 hours)” in [Table 1]), the recrystallization temperature of the biaxially oriented PET film under different conditions (expressed as “Recrystallization temperature Tc (20) (° C.)” and “Recrystallization temperature Tc (40) (° C.)” in [Table 1]) and the difference thereof (expressed as “Difference ΔTc (° C.)” in [Table 1]), and the physical properties of the biaxially oriented PET film (expressed as “Breaking strength (kgf/mm²) in longitudinal direction”, “Young's modulus (kgf/mm²) in longitudinal direction”, “Breaking strength (kgf/mm²) in horizontal direction”, and “Young's modulus (kgf/mm²) in horizontal direction” in [Table 1]).

Molar percentage concentration (mol %) of crystallization inhibiting material in PET resin mixture: accurately weigh 1.000±0.0003 g sample and 30±0.1 ml 0.1% triethylene glycol (TEG)/methanol solution and put the above into a steel bottle; heat at 225° C. for 2.5 hours, cool with cold water and let stand; open the cap of the steel bottle and pipette the upper clear solution into a glass bottle; centrifuge the solution in the glass bottle and take the upper clear solution to analyze the composition of the crystallization inhibiting material by gas chromatography (GC) and calculate the content.

The film breakage rate may be the number of film breakage per unit time under the same orientation conditions (including the above longitudinal orientation or horizontal orientation).

Productivity evaluation: ◯: the orientation conditions were not adjusted and the number of film breakage per 24 hours was less than or equal to 3. Δ: the orientation conditions were not adjusted and the number of film breakage per 24 hours was between 4 and 6; or the orientation conditions needed to be adjusted but the number of film breakage per 24 hours was less than or equal to 3. x: the orientation conditions were not adjusted and the number of film breakage per 24 hours was greater than or equal to 7; or the orientation conditions needed to be adjusted but the number of film breakage per 24 hours was greater than or equal to 4.

Recrystallization temperature Tc (20) (° C.): after accurately weighing 8±1 mg of the sample, analyze the sample by DSC. The temperature was increased from 25° C. to 300° C. at a heating rate of 20° C./min, and then the temperature was decreased at 20° C./min and the crystallization peak was analyzed.

Recrystallization temperature Tc (40) (° C.): after accurately weighing 8±1 mg of the sample, analyze the sample by DSC. The temperature was increased from 25° C. to 300° C. at a heating rate of 20° C./min, and then the temperature was decreased at 40° C./min and the crystallization peak was analyzed.

Breaking strength/Young's modulus: the test was conducted in accordance with ASTM D882, wherein the test sample dimensions were: width 15 mm, length 100 mm, and tensile speed 200 mm/s.

TABLE 1

| | Example | Example | Example | Example | Example | Example | Example | Example | Comparative | Comparative |
|---|---|---|---|---|---|---|---|---|---|---|
| | 1 | 2 | 3 | 4 | 5 | 6 | 7 | 8 | example 1 | example 2 |
| Virgin PET | 0 | 0 | 0 | 0 | 0 | 10 | 20 | 35 | 0 | 0 |
| chip ratio | | | | | | | | | | |
| (wt %) | | | | | | | | | | |
| Physically | 65 | 65 | 65 | 65 | 65 | 55 | 55 | 45 | 65 | 65 |
| recycled | | | | | | | | | | |
| PET chip | | | | | | | | | | |
| ratio (wt %) | | | | | | | | | | |
| Chemically | 35 | 35 | 35 | 35 | 35 | 35 | 25 | 20 | 35 | 35 |
| recycled | | | | | | | | | | |
| PET chip | | | | | | | | | | |
| ratio (wt %) | | | | | | | | | | |
| Recycling | 100 | 100 | 100 | 100 | 100 | 90 | 80 | 65 | 100 | 100 |
| ratio (wt %) | | | | | | | | | | |
| Molar | 3.7 | 4.8 | 7.2 | 6.1 | 2.5 | 2.8 | 4 | 5.5 | 1.7 | 8.5 |
| percentage | | | | | | | | | | |
| concentration of | | | | | | | | | | |
| crystallization | | | | | | | | | | |
| inhibiting | | | | | | | | | | |
| material in | | | | | | | | | | |
| PET resin | | | | | | | | | | |
| mixture (mol %) | | | | | | | | | | |
| Thickness | 10 | 50 | 100 | 188 | 250 | 50 | 50 | 50 | 50 | 50 |
| (μm) of film | | | | | | | | | | |
| Film | 1 | 0 | 0 | 1 | 0 | 0 | 1 | 0 | 10 | 3 |
| breakage rate | | | | | | | | | | |
| (occurrence/ | | | | | | | | | | |
| 24 hours) | | | | | | | | | | |
| Are | No | No | No | No | No | No | No | No | Yes | Yes |
| orientation | | | | | | | | | | |
| conditions | | | | | | | | | | |
| adjusted? | | | | | | | | | | |
| Productivity | ∘ | ∘ | ∘ | ∘ | ∘ | ∘ | ∘ | ∘ | x | Δ |
| evaluation | | | | | | | | | | |
| Melting point | 248.93 | 247.72 | 245.08 | 246.29 | 250.25 | 249.92 | 248.60 | 246.95 | 251.13 | 243.65 |
| temperature Tm | | | | | | | | | | |
| Recrystallization | 186.03 | 172.21 | 173.23 | 180.52 | 187.92 | 189.50 | 185.47 | 181.73 | 191.86 | 172.72 |
| temperature | | | | | | | | | | |
| Tc (20) (°C) | | | | | | | | | | |
| Recrystallization | 168.52 | 156.43 | 151.19 | 158.34 | 172.25 | 173.87 | 166.00 | 162.85 | 177.08 | 147.85 |
| temperature | | | | | | | | | | |
| Tc (40) (°C) | | | | | | | | | | |
| Difference | 17.51 | 15.78 | 22.04 | 22.18 | 15.67 | 15.63 | 19.47 | 18.88 | 14.78 | 24.87 |
| ΔTc (°C) | | | | | | | | | | |
| Breaking strength | 24.37 | 23.98 | 25.17 | 23.12 | 25.89 | 22.78 | 22.98 | 24.55 | 19.88 | 17.29 |
| (kgf/mm²) in | | | | | | | | | | |
| longitudinal | | | | | | | | | | |
| direction | | | | | | | | | | |
| Young's modulus | 452 | 437 | 447 | 428 | 456 | 415 | 432 | 444 | 373 | 278 |
| (kgf/mm²) in | | | | | | | | | | |
| longitudinal | | | | | | | | | | |
| direction | | | | | | | | | | |
| Breaking strength | 25.58 | 24.33 | 25.98 | 25.60 | 27.89 | 25.61 | 25.51 | 26.25 | 21.15 | 18.21 |
| (kgf/mm²) in | | | | | | | | | | |
| horizontal | | | | | | | | | | |
| direction | | | | | | | | | | |
| Young's modulus | 478 | 463 | 461 | 455 | 470 | 432 | 457 | 461 | 403 | 303 |
| (kgf/mm²) in | | | | | | | | | | |
| horizontal | | | | | | | | | | |
| direction | | | | | | | | | | |

Based on the above, the invention introduces the crystallization inhibiting material into the PET resin mixture, and improves the crystallinity of the biaxially oriented PET film via the crystallization inhibiting effect thereof, so as to produce better productivity evaluation, thereby achieving good product competitiveness.

What is claimed is:

1. A biaxially oriented PET film, made of a PET resin mixture, wherein the PET resin mixture comprises a PET material and a crystallization inhibiting material, such that when the biaxially oriented PET film is analyzed by differential scanning calorimetry, when the biaxially oriented PET film is cooled from a molten state at cooling rates of 20° C./min and 40° C./min respectively, a difference between a first recrystallization temperature and a second recrystallization temperature observed is greater than 15° C. and less than or equal to 23° C.

2. The biaxially oriented PET film of claim 1, wherein a molar percentage concentration of the crystallization inhibiting material in the PET resin mixture is between 2 mol % and 8 mol %.

3. The biaxially oriented PET film of claim 1, wherein the crystallization inhibiting material comprises isophthalic acid, neopentyl glycol, diethylene glycol, 1,4-cyclohexanedimethanol, or a combination thereof.

4. The biaxially oriented PET film of claim 1, wherein the crystallization inhibiting material is a combination of isophthalic acid and diethylene glycol.

5. The biaxially oriented PET film of claim 1, wherein the PET material comprises a recycled PET material, a virgin PET material, or a combination thereof.

6. The biaxially oriented PET film of claim 1, wherein the first recrystallization temperature is greater than 170° C.

7. The biaxially oriented PET film of claim 1, wherein the second recrystallization temperature is between 150° C. and 175° C.

8. The biaxially oriented PET film of claim 1, wherein a thickness of the biaxially oriented PET film is greater than 10 micrometers.

9. A manufacturing method of a biaxially oriented PET film, comprising:
providing PET chips, wherein the PET chips at least comprise chemically recycled PET chips, and the chemically recycled PET chips have a crystallization inhibiting material;
melting and extruding the PET chips to form an unoriented thick sheet, wherein the molten PET chips are a PET resin mixture; and
biaxially orienting the thick sheet to form the biaxially oriented PET film, wherein the biaxially oriented PET film is analyzed by differential scanning calorimetry, and when the biaxially oriented PET film is cooled from a molten state at cooling rates of 20° C./min and 40° C./min, respectively, a difference between a first recrystallization temperature and a second recrystallization temperature observed is greater than 15° C. and less than or equal to 23° C.

10. The manufacturing method of the biaxially oriented PET film of claim 9, wherein the PET chips further comprise one or two of virgin PET chips and physically recycled PET chips.
